(19) United States
(12) Patent Application Publication
(10) Pub. No.: US 2026/0358468 A1
(43) Pub. Date: Nov. 12, 2026

(54) METHOD AND APPARATUS FOR PROCESSING A SIGNAL

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/465,847

(22) Filed: Jan. 30, 2026

Related U.S. Application Data
(63) Continuation of application No. PCT/CN2024/077107, filed on Feb. 9, 2024.
(60) Provisional application No. 63/530,324, filed on Aug. 2, 2023.

(51) Int. Cl. G01S 7/35; G01S 7/03; G01S 13/32; G01S 13/58

(52) U.S. Cl. CPC G01S 7/352; G01S 7/03; G01S 13/32; G01S 13/583

(57) ABSTRACT

Embodiments of the present application provide a method and an apparatus for processing a signal. In the present application, an integrated sensing and communication (ISAC) signal transmitter generates an ISAC signal that includes a sensing signal and a communication signal, and a time-frequency resource allocated to the sensing signal overlaps with a time-frequency resource allocated to the communication signal. The sensing signal may be a linear frequency modulation based (LFM-based) signal, and the ISAC signal transmitter punctures the sensing signal by the communication signal on an overlapped time-frequency resource. At least one communication frequency band of a total bandwidth of the ISAC signal can be allocated to the communication signal, and the rest of the total bandwidth of the ISAC signal is allocated to the sensing signal.

### CROSS-REFERENCE TO RELATED APPLICATIONS

The present application is a continuation of International Patent Application PCT/CN2024/077107, filed on Feb. 9, 2024, which claims the benefit of U.S. Patent Application No. 63/530,324, filed on Aug. 2, 2023. The entire contents of the aforementioned applications are hereby incorporated by reference.

### TECHNICAL FIELD

Embodiments of the present invention relate to the field of wireless technologies, and more specifically, to a method and an apparatus for processing a signal.

### BACKGROUND

Low power consumption will be a crucial factor in future wireless systems. Idle and inactive states have been defined in 5th generation (5G) standard for a user equipment (UE) operating in a low power mode. In such states, a UE turns off its unnecessary circuit to lower the power consumption. Similar power states/modes or even new low states/modes with more stringent constraints on power consumption are expected in the future systems such as the 6th generation (6G) system. To increase efficiency of the wireless systems, one of viable techniques is to integrate communications and sensing functionalities and develop an integrated sensing and communication (ISAC) system. Many advantages of the ISAC system are provided at cost of more complex receiver architectures and protocols. One of important challenges in the ISAC system is to manage the mutual interference between a communication signal and a sensing signal so that sensing and communication performances are not highly compromised as a result of integration.

Therefore, it is challenging to optimize the ISAC system so as to achieve both communication and sensing objectives while avoiding the excessive mutual interference between the communication signal and the sensing signal.

### SUMMARY

Embodiments of the present application provide a method and an apparatus for processing a signal, which provides a framework to simultaneously transmit a communication signal and a sensing signal in an ISAC system without a large compromise in sensing and communication performances.

According to a first aspect, there is provided a method for processing a signal. The method can be implemented by a signal transmitter. The method includes: generating an integrated sensing and communication (ISAC) signal, where the ISAC signal includes a sensing signal and a communication signal, a first time-frequency resource allocated to the sensing signal overlaps with a second time-frequency resource allocated to the communication signal, the sensing signal includes a linear frequency modulation based (LFM-based) signal, the sensing signal is punctured by the communication signal on the overlapped time-frequency resource, and at least one communication frequency band of a total bandwidth of the ISAC signal is allocated to the communication signal, and the rest of the total bandwidth of the ISAC signal is allocated to the sensing signal; transmitting the ISAC signal; and transmitting a puncturing indication to a first signal receiver that is to receive the sensing signal, where the puncturing indication includes first information for processing the ISAC signal to obtain the sensing signal from the ISAC signal.

The proposed solution enables integration of a communication signal and a sensing signal with minimal performance degradation. What's more, it enables transmission of urgent communication messages using a part of a bandwidth of the sensing signal, and enables low complexity sensing using a large bandwidth.

Use of the LFM-based signal for sensing processing to obtain estimate of sensing parameters (such as range, velocity, position, orientation, etc.) achieves a low complexity and a low power consumption at the signal receiver.

In an implementation of the first aspect, the total bandwidth of the ISAC signal is B which corresponds to frequency boundaries f₀ and f₁, B=f₁−f₀, the at least one communication frequency band includes a first communication frequency band of [B₁, B₂], B₁≥f₀, and B₂≤f₁.

In an implementation of the first aspect, the sensing signal is a single LFM signal, and the sensing signal is cut off in a first time interval that is a part of a total time duration of the ISAC signal.

In an implementation of the first aspect, a chirp rate of the single LFM signal is α=B/T, T is the total time duration of the ISAC signal; and the first time interval is denoted with

$$[ {T}_{1} , {T}_{2} ] , {T}_{1} = \frac{{B}_{1}}{B} T , {T}_{2} = \frac{{B}_{2}}{B} T ,$$

T₁ and T₂ are positive numbers; or the first time interval is denoted with

$$[ {T}_{1} - {δ}_{1} , {T}_{2} + {δ}_{2} ] , {T}_{1} = \frac{{B}_{1}}{B} T , {T}_{2} = \frac{{B}_{2}}{B} T ,$$

T₁, T₂, δ₁ and δ₂ are positive numbers.

In an implementation of the first aspect, a chirp rate of the single LFM signal is −α=−B/T, T is the total time duration of the ISAC signal; and the first time interval is denoted with

$$[ {T}_{1} , {T}_{2} ] , {T}_{1} = \frac{B - {B}_{2}}{B} T , {T}_{2} = \frac{B - {B}_{1}}{B} T ,$$

T₁, T₂, δ₁ and δ₂ are positive numbers; or the first time interval is denoted with

$$[ {T}_{1} - {δ}_{1} , {T}_{2} + {δ}_{2} ] , {T}_{1} = \frac{B - {B}_{2}}{B} T , {T}_{2} = \frac{B - {B}_{1}}{B} T ,$$

T₁, T₂, δ₁ and δ₂ are positive numbers.

In an implementation of the first aspect, the sensing signal is a frequency modulated continuous waveform (FMCW) signal that includes M LFM signals with a same chirp rate and a same time duration, and each of the M LFM signals is cut off in a first time interval, M is a positive integer greater than one.

In an implementation of the first aspect, the same chirp rate of the M LFM signals is α=MB/T, and the same duration of the M LFM signals is T/M, the i-th of the M LFM signals is cut off in the first time interval of

$$[ {T}_{1}^{i} , {T}_{2}^{i} ] or [ {T}_{1}^{i} - {δ}_{1}^{i} , {T}_{2}^{i} + {δ}_{2}^{i} ] , {T}_{1}^{i} = \frac{T}{M} ( i - 1 + \frac{{B}_{1}}{B} ) ,$$

$${T}_{2}^{i} = \frac{T}{M} ( i - 1 + \frac{{B}_{2}}{B} ) , i ∈ \{ 1 , 2 , … , M \} , {δ}_{1}^{i} and {δ}_{2}^{i}$$

are positive numbers, and T is a total time duration of the ISAC signal.

In an implementation of the first aspect, the same chirp rate of the M LFM signals is −α=−MB/T, and the same time duration of the M LFM signals is T/M, the i-th of the M LFM signals is cut off in the first time interval of

$$[ {T}_{1}^{i} , {T}_{2}^{i} ] or [ {T}_{1}^{i} - {δ}_{1}^{i} , {T}_{2}^{i} + {δ}_{2}^{i} ] , {T}_{1}^{i} = \frac{T}{M} ( i - \frac{{B}_{2}}{B} ) ,$$

$${T}_{2}^{i} = \frac{T}{M} ( i - \frac{{B}_{1}}{B} ) , i ∈ \{ 1 , 2 , … , M \} , {δ}_{1}^{i} and {δ}_{2}^{i}$$

are positive numbers, and T is a total time duration of the ISAC signal.

In an implementation of the first aspect, the sensing signal is a single triangular signal that includes a first LFM signal and a second LFM signal, a time duration allocated to the first LFM signal and a time duration allocated to the second LFM signal are half a total time duration of the sensing signal, chirp rates of the first LFM signal and the second LFM signal are

$$α = \frac{2 B}{T} and - α = - \frac{2 B}{T}$$

respectively, the first LFM signal is cut off in a first time duration and the second LFM signal is cut off in a second time duration, T is a total time duration of the ISAC signal.

In an implementation of the first aspect, the first time interval is denoted with [T₁, T₂] and the second time interval is denoted with

$$[ {T}_{3} , {T}_{4} ] , {T}_{1} = \frac{{TB}_{1}}{2 B} , {T}_{2} = \frac{{TB}_{2}}{2 B} , {T}_{3} = T ( 1 - \frac{{B}_{2}}{2 B} ) , {T}_{4} = T ( 1 - \frac{{B}_{1}}{2 B} ) ; or$$

$${T}_{1} = \frac{B - {B}_{2}}{2 B} T , {T}_{2} = \frac{B - {B}_{1}}{2 B} , {T}_{3} = \frac{T}{2} ( 1 + \frac{{B}_{1}}{B} ) , {T}_{4} = \frac{T}{2} ( 1 + \frac{{B}_{2}}{B} ) ,$$

T₁, T₂, T₃ and T₄ are positive numbers.

In an implementation of the first aspect, the sensing signal is a triangular signal that includes 2M LFM signal(s), the 2M LFM signal(s) includes M first LFM signal(s) and M second LFM signal(s), a first chirp rate of the M first LFM signal(s) and a second chirp rate of the M second LFM signal(s) are the opposite, each of the 2M LFM signal(s) is allocated with a time duration of

$$\frac{T}{2 M} ,$$

each of the M first LFM signal(s) is cut off in a first time interval, and each of the M second LFM signal(s) is cut off in a second time interval, M is a positive integer greater than one, and T is a total time duration of the ISAC signal.

In an implementation of the first aspect, the first chirp rate is

$$α = \frac{2 B}{T} ,$$

the second chirp rate is

$$- α = - \frac{2 B}{T} ,$$

the first time interval is denoted with

$$[ {T}_{1}^{i} , {T}_{2}^{i} ]$$

and the second time interval is denoted with

$$[ {T}_{3}^{i} , {T}_{4}^{i} ] , {T}_{1}^{i} = \frac{( i - 1 ) T}{M} + \frac{T}{2 M} \frac{{B}_{1}}{B} , \\ {T}_{2}^{i} = \frac{( i - 1 ) T}{M} + \frac{T}{2 M} \frac{{B}_{2}}{B} , {T}_{3}^{i} = \frac{( i - 1 ) T}{M} + \frac{T}{M} ( 1 - \frac{{B}_{2}}{2 B} ) , \\ {T}_{4}^{i} = \frac{( i - 1 ) T}{M} + \frac{T}{M} ( 1 - \frac{{B}_{1}}{2 B} ) , i ∈ \{ 1 , 2 , ... , M \} .$$

In an implementation of the first aspect, the first chirp rate is

$$- α = - \frac{2 B}{T} ,$$

the second chip rate is

$$α = \frac{2 B}{T} ,$$

the first time interval is denoted with

$$[ {T}_{1}^{i} , {T}_{2}^{i} ]$$

and the second time interval is denoted with

$$[ {T}_{3}^{i} , {T}_{4}^{i} ] , {T}_{1}^{i} = \frac{( i - 1 ) T}{M} + \frac{T}{2 M} \frac{B - {B}_{2}}{B} , \\ {T}_{2}^{i} = \frac{( i - 1 ) T}{M} + \frac{T}{2 M} \frac{B - {B}_{1}}{B} , {T}_{3}^{i} = \frac{( i - 1 ) T}{M} + \frac{T}{M} ( 1 - \frac{{B}_{1}}{B} ) , \\ {T}_{4}^{i} = \frac{( i - 1 ) T}{M} + \frac{T}{M} ( 1 - \frac{{B}_{2}}{B} ) , i ∈ \{ 1 , 2 , ... , M \} .$$

In an implementation of the first aspect, the LFM-based signal includes M single LFM signals with a same chirp rate or with different chirp rates per LFM signal, each of the M single LFM signals is cut off in a time interval.

In an implementation of the first aspect, the time interval is denoted with

$$[ {T}_{1}^{i} , {T}_{2}^{i} ] , i ∈ \{ 1 , 2 , ... , M \} , the {T}_{1}^{i} and {T}_{2}^{i}$$

is obtained according to a function of B, T, B₁, B₂, B is the total bandwidth of the ISAC signal, and T is a total time duration of the ISAC signal.

In an implementation of the first aspect, generating the ISAC signal includes: generating and puncturing the sensing signal; generating the communication signal; and adding the punctured sensing signal and the communication signal to form the ISAC signal.

In an implementation of the first aspect, the method further includes: receiving a capability report from the first signal receiver, where capability report indicates whether the first signal receiver is capable of notch filtering in frequency domain.

In an implementation of the first aspect, the first information indicates sensing signal configuration, the sensing signal configuration includes one or more parameters of: a type of the LFM-based signal, the number of the LFM signals included in the LFM-based signal, chirp rate(s) of LFM signal(s) included in the LFM-based signal, starting frequency of the LFM-based signal, a bandwidth of the LFM-based signal, and the type of the LFM-based signal is used to indicate the LFM-based signal is the single LFM signal, the FMCW signal, the triangular signal or a general LFM-based signal.

In an implementation of the first aspect, the puncturing indication indicates a scenario in which the ISAC signal is used, the scenario includes a first scenario or a second scenario, the first scenario represents a scenario in which interference of the communication signal on the sensing signal is to be removed and a fraction of

$$\frac{{T}_{com}}{T}$$

is less than a first threshold, T_{com} is a total time duration of the communication signal which has a frequency content in bandwidth B, and T is a total time duration of the ISAC signal; the second scenario represents a scenario in which interference of the communication signal on the sensing signal is to be removed and a fraction of

$$\frac{{T}_{com}}{T}$$

is greater than a second threshold, T_{com} is a total time duration of the communication signal which has a frequency content in the bandwidth B, and T is a total time duration of the ISAC signal.

In an implementation of the first aspect, if the puncturing indication indicates the first scenario, the puncturing indication further indicates all beginnings and endings of the communication signal in time domain, the beginnings and the endings include T₁ and T₂ respectively.

In an implementation of the first aspect, the puncturing indication is transmitted on top of the LFM-based signal.

In an implementation of the first aspect, if the puncturing indication indicates the second scenario, the puncturing indication further indicates frequency boundaries of each of the at least one communication frequency band.

In an implementation of the first aspect, the puncturing indication is transmitted with a broadcasting message sent over a beam direction over which the communication signal is transmitted.

Note that, description of the sensing signal in all the implementations of the first aspect also applies to the second and third aspects below, which will not be repeated in the second and third aspects.

According to a second aspect, there is provided a method for processing a signal. The method may be implemented by a signal receiver. The method includes: receiving an integrated sensing and communication (ISAC) signal and a puncturing indication, where the ISAC signal includes a sensing signal and a communication signal, a first time-frequency resource allocated to the sensing signal overlaps with a second time-frequency resource allocated to the communication signal, the sensing signal includes a chirp-based signal, the sensing signal is punctured by the communication signal on the overlapped time-frequency resource, at least one communication frequency band of a total bandwidth of the ISAC signal is allocated to the communication signal, the rest of the total bandwidth of the ISAC signal is allocated to the sensing signal, the puncturing indication includes first information for processing the ISAC signal to obtain the sensing signal from the ISAC signal; filtering, according to the puncturing indication, the ISAC signal to remove interference of the communication signal on the sensing signal; and processing the filtered signal to obtain estimate of sensing parameter(s) of interest.

In an implementation of the second aspect, the total bandwidth of the ISAC signal is B which corresponds to frequency boundaries f₀ and f₁, B=f₁−f₀, the at least one communication frequency band comprises a first communication frequency band of [B₁, B₂], B₁≥f₀, and B₂≤f₁.

In an implementation of the second aspect, the method further includes: transmitting a capability report, where the capability report indicates whether the signal receiver is capable of notch filtering in a frequency domain.

In an implementation of the second aspect, the first information indicates sensing signal configuration, the sensing signal configuration includes one or more parameters of: a type of the LFM-based signal, the number of the LFM signals included in the LFM-based signal, chirp rate(s) of LFM signal(s) included in the LFM-based signal, beginning frequency of the LFM-based signal, a bandwidth of the LFM-based signal, and the type of the LFM-based signal is used to indicate the LFM-based signal is the single LFM signal, the FMCW signal, the triangular signal or a general LFM-based signal.

In an implementation of the second aspect, the puncturing indication indicates a scenario in which the ISAC signal is used, the scenario includes a first scenario or a second scenario, the first scenario represents a scenario in which interference of the communication signal on the sensing signal is to be removed and a fraction of

$$\frac{{T}_{com}}{T}$$

is less than a first threshold, T_{com} is a total time duration of the communication signal which has a frequency content in the bandwidth B, and T is a total time duration of the ISAC signal; the second scenario represents a scenario in which interference of the communication signal on the sensing signal is to be removed and a fraction of

$$\frac{{T}_{com}}{T}$$

is greater than a second threshold, T_{com} is a total time duration of the communication signal which has a frequency content in the bandwidth B, and T is a total time duration of the ISAC signal.

In an implementation of the second aspect, the fraction of

$$\frac{{T}_{com}}{T}$$

is less than a first threshold, and the puncturing indication indicates the first scenario; where filtering the ISAC signal to remove the interference of the communication signal on the sensing signal includes: filtering the ISAC signal in a time domain to remove the interference of the communication signal on the sensing signal.

In an implementation of the second aspect, the puncturing indication further indicates all beginnings and endings of the communication signal in the time domain, and the beginnings and the endings include T₁ and T₂ respectively.

In an implementation of the second aspect, the fraction of

$$\frac{{T}_{com}}{T}$$

is greater than the second threshold, and the puncturing indicates the second scenario; where filtering the ISAC signal to remove the interference of the communication signal on the sensing signal includes: filtering, using a notch filter, the ISAC signal in a frequency domain to remove the interference of the communication signal on the sensing signal.

In an implementation of the second aspect, the puncturing indication further indicates frequency boundaries B₁ and B₂ of a first communication frequency band which belong to the at least one communication frequency band.

In an implementation of the second aspect, the method further includes: filtering, according to second information, the ISAC signal to remove interference of the sensing signal on the communication signal; and processing the filtered signal to decode the communication signal.

In an implementation of the second aspect, the method further includes: obtaining the second information.

According to a third aspect, there is provided a method for processing a signal. The method may be implemented by a signal receiver. The method includes: receiving an integrated sensing and communication (ISAC) signal, where the ISAC signal includes a sensing signal and a communication signal, a first time-frequency resource allocated to the sensing signal overlaps with a second time-frequency resource allocated to the communication signal, the sensing signal includes a chirp-based signal, the sensing signal is punctured by the communication signal on the overlapped time-frequency resource, at least one communication frequency band of a total bandwidth of the ISAC signal is allocated to the communication signal, and the rest of the total bandwidth of the ISAC signal is allocated to the sensing signal; filtering the at least one communication frequency band to remove interference of the sensing signal on the communication signal; and processing the filtered signal to decode the communication signal.

In an implementation of the third aspect, the total bandwidth of the ISAC signal is B which corresponds to frequency boundaries f₀ and f₁, B=f₁−f₀, the at least one communication frequency band comprises a first communication frequency band of [B₁, B₂], B₁≥f₀, and B₂≤f₁.

In an implementation of the third aspect, the method further includes: receiving second information that indicates the at least one communication frequency band; filtering the at least one communication frequency band to remove the interference of the sensing signal on the communication signal, includes: filtering the at least one communication frequency band, according to the second information, to remove the interference of the sensing signal on the communication signal.

According to a fourth aspect, there is provided a communication apparatus having a function or module to perform the method in any one of the first aspect to the third aspect, or any one of the implementations in these aspects.

According to a fifth aspect, there is provided an integrated circuit. The integrated circuit includes at least one processor, where the at least one processor is coupled to at least one memory. The at least one memory is configured to store one or more instructions and/or executable computer code. The at least one processor is configured to invoke the one or more instructions and/or executable computer code, so that a communication apparatus comprising the integrated circuit can perform the method of any one of the first aspect to the third aspect, or any one of the possible implementations in these aspects. Optionally, the integrated circuit may further include the at least one memory. Optionally, the integrated circuit may further include a communication interface, and the communication interface is configured to input and/or output information or data.

According to a sixth aspect, there is provided a communication apparatus. The communication apparatus includes one or more circuits and one or more communication interfaces. The one or more communication interfaces may include a first interface for receiving (that is, inputting) information and/or data that is to be processed by the one or more circuits and a second interface for transmitting (that is, outputting) information and/or data processed by the one or more circuit. The one or more circuits are configured to process the information and/or data that is to be processed so that the communication apparatus performs the method in any one of the first aspect to the third aspect, or any one of the implementations in these aspects.

According to a seventh aspect, there is provided a communication system. The communication system may include at least one communication apparatus according to the method in any one of the first aspect to the third aspect.

According to an eighth aspect, there is provided a computer storage medium that stores executable computer code, and the executable computer code is used to execute one or more instructions for the method according to any one of the first aspect to the third aspect, or any one of the possible implementations in these aspects.

According to a ninth aspect, there is provided a computer program product including one or more instructions, and when the computer product program runs on a computer, the computer performs the method according to the any one of the first aspect to the third aspect, or any one of the possible implementations in these aspects.

### BRIEF DESCRIPTION OF DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limited to scale, in which:

FIG. 1 illustrates a chirp signal representation in a time-frequency domain.

FIG. 2 illustrates a FMCW signal in a time-frequency domain.

FIG. 3 illustrates a triangular signal in a time-frequency domain.

FIG. 4 is a schematic flow chart of a method (200) for processing a signal according to some embodiments of the present application.

FIG. 5 shows one example of puncturing a sensing signal by a communication signal.

FIG. 6 shows one example for frequency allocation between a sensing signal and a communication signal.

FIG. 7 shows an example of a single chirp sensing signal with puncturing.

FIG. 8 shows another example of a single chirp sensing signal with puncturing.

FIG. 9 shows an example of a FMCW signal with puncturing.

FIG. 10 shows another example of a FMCW signal with puncturing.

FIG. 11 shows an example of a single triangular signal with puncturing.

FIG. 12 shows another example of a single triangular signal with puncturing.

FIG. 13 shows an example of a triangular signal including multiple chirp signals with puncturing.

FIG. 14 shows another example of a triangular signal including multiple chirp signals with puncturing.

FIG. 15 shows a general chirp-based signal with puncturing.

FIG. 16 is an example of an ISAC transmitter when the sensing signal is taken to be a chirp-based signal.

FIG. 17 illustrates a first scenario where a time duration of communication signal is relatively small with respect to that of an ISAC signal.

FIG. 18 illustrates a second scenario where a time duration of communication signal is relatively larger with respect to that of an ISAC signal.

FIG. 19 illustrates one option for ISAC structure when a sensing signal is taken to be a chirp-based signal.

FIG. 20 illustrates another option for ISAC structure when a sensing signal is taken to be a chirp-based signal.

FIG. 21 illustrates a single frequency band and multiple frequency bands from a bandwidth of an ISAC signal allocated respectively to a communication signal.

FIG. 22 shows another example of a single chirp sensing signal with puncturing.

FIG. 23 is a schematic block diagram of a communication apparatus according to some embodiments of the present application.

FIG. 24 is a schematic block diagram of a communication apparatus according to some embodiments of the present application.

### DETAILED DESCRIPTION OF EMBODIMENTS

In order to understand features and technical contents of embodiments of the present application in detail, implementations of the embodiments of the present application will be described in detail below with reference to the accompanying drawings, and the attached drawings are only for reference and illustration purposes, and are not intended to limit the embodiments of the present applications. In the following technical descriptions, for ease of explanation, numerous details are set forth to provide a thorough understanding of the disclosed embodiments.

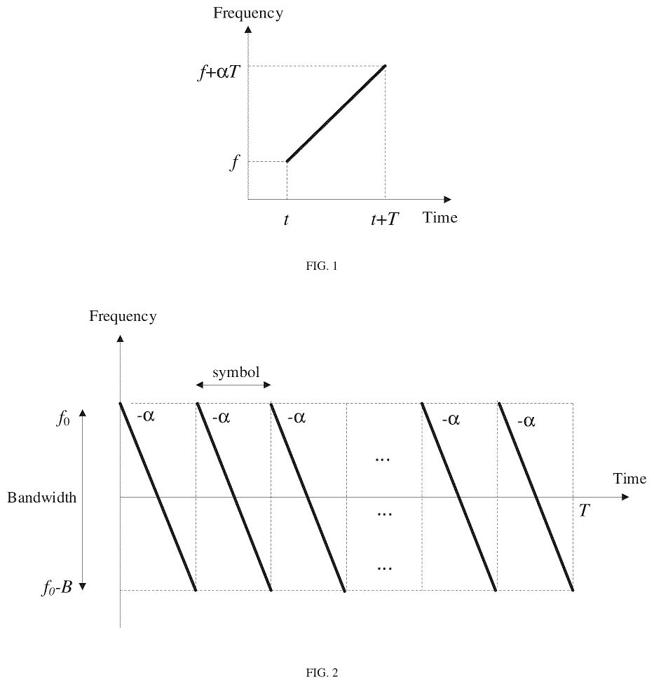

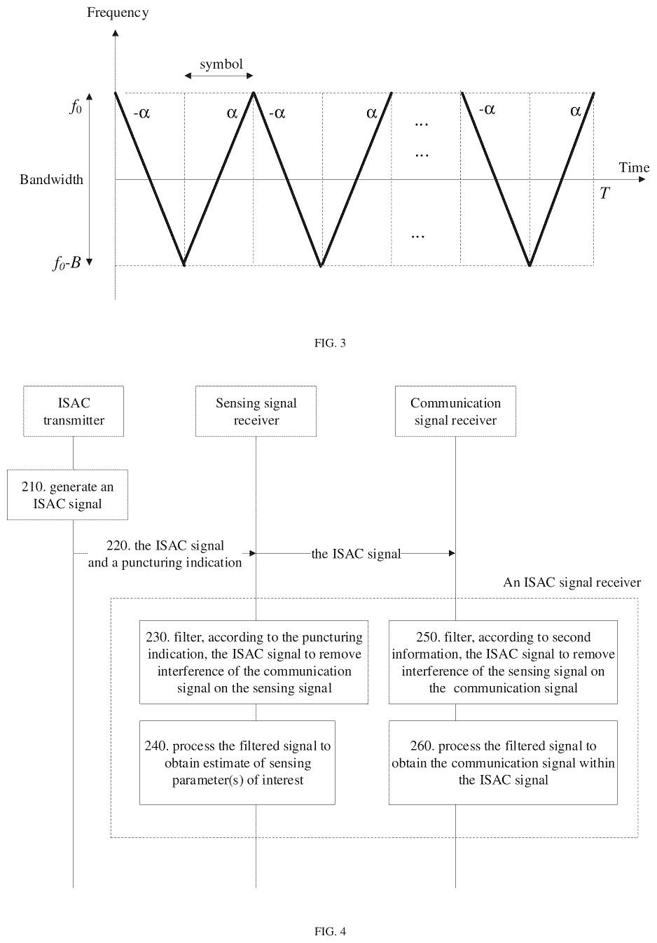

Related technical concepts and technologies are introduced first in order to understand the proposed solution of the present application.
(1) chirp signal: chirp is a signal whose frequency is a linear function of time with a slope that is called chirp rate (also known as chirp slope). FIG. 1 illustrates a chirp signal representation in a time frequency domain. The starting time and frequency of the chirp signal is t and f, respectively. The chirp rate is a and a time duration of the chirp signal is T.
(2) chirp-based signals: they are defined as the ones constructed based on single chirp signal introduced above. Two of the important examples of chirp-based signals are introduced below. The first example shown in FIG. 2 is called frequency modulated continuous waveform (FMCW) signal which includes multiple parallel single chirps multiplexed in the time domain. The second example, depicted in FIG. 3, is called a triangular signal which is constructed by chirp signals with opposite sign chirp rates. We can also define a general format for the chirp-based signal in which chirp rates can vary across symbols as will be explained throughout the present application.

Note that, the chirp-based signal also is called a linear frequency modulation based (LFM-based) signal, and they are the same thing from a technical perspective.

Low power consumption will be a crucial factor in future wireless systems. Idle and inactive states have been defined in new radio (NR) standard for UEs operating in a low power mode. In such states, a UE turns off its unnecessary circuitry to lower the power consumption. It is expected to have similar low power states/modes or even new lower power states/modes with more stringent constraints on power consumption in the future network, for example, the 6G system. Note that, terms of low power state and low power mode are used interchangeably throughout the present application. In scenarios where power consumption is important, operations in radio frequency (RF) analog domain are preferred to operations in the digital baseband domain. The reason is that operations in digital baseband domain increases power consumption significantly especially at higher frequencies such as millimeter wave band frequencies. One of the family enabling having most of the operations in the analog RF domain is linear frequency modulated (LFM) waveform family which is also known as chirp signal family.

To increase efficiency of the wireless system, one of the viable techniques is to integrate communications and sensing functionalities and develop an integrated sensing and communication (ISAC) system. The main advantages of using the ISAC system compared to using separate communication and sensing system are: (1) saving hardware cost which can be fully/partially shared between communication and sensing system; (2) reducing required time-frequency resources. However, such advantages are provided at the cost of more complex receiver architectures and protocols. One of the important challenges in the ISAC system is to manage the mutual interference between communication and sensing signals so that the sensing and communication performances are not highly compromised as a result of integration. Furthermore, sensing and communication signals normally have different characteristics, for example, sensing signal has high bandwidth to get good range resolution and communication signal is optimized to maximize the spectral efficiency to embed as much as information in a limited time/frequency resource. Therefore, it is challenging to optimize the ISAC system so as to achieve both communication and sensing objectives while avoiding the excessive mutual interference between sensing and communication signals. The present application provides detailed solutions for designing the ISAC system in terms of signal and protocol.

There is prior art that provides solutions for signal and protocol design in the IASC system. A first one is a solution multiplexing sensing and communication signals in time-frequency domain. In this solution, different time-frequency resources are considered for sensing and communication signals. It requires pre-configuration of resources between the sensing and communication signals. There may be scenarios in future system in which we may want to accommodate an urgent communication transmission within time-frequency resources assigned to sensing. However, this solution is not effective since it requires the pre-configuration of resources.

A second one is a solution multiplexing sensing and communication signals in spatial domain. In this solution, different spatial directions are considered for sensing and communication signals. There are a couple of disadvantages in adopting this solution. First, it is assumed that directional transmissions are feasible which may be the case as such require antenna arrays at transmitter which may not be the case. Second, the sensing and communication receivers (e.g. a sensing UE and communication UE) should be sufficiently separated in the spatial domain which is not always the case, i.e., there may be scenarios in which there is demand for sensing and communication from receivers which are not sufficiently separated in space. There may be scenarios in future system in which we may want to accommodate an urgent communication transmission within time-frequency resources assigned to sensing. This solution will not be effective if there is not enough separation between the sensing and communication receivers. It is worth nothing that the notion of sufficient separation depends on the directionality of transmissions. Typically, if the transmissions are more directional, i.e., the beamwidth of the transmitted signal is lower, sufficient separation threshold (in an angular domain) is lower.

A third one is a solution multiplexing sensing and communication signals in power domain. In this solution, the sensing and communication signals are separated in power domain. In other words, same time-frequency resources and spatial directions are used for sensing and communication signals, but different power coefficients are used to transmit the sensing and communication signals. The receiver can decode the sensing and communication signals sequentially. However, using this solution compromises the performance due the mutual interference.

Given that, the present application provides a framework to simultaneously transmit communication signal and sensing signal over overlapping time-frequency resources without a large compromise in sensing and communication performance. Such a solution can be used in future ISAC system for a variety of scenarios.

The proposed solution is related to a variety of scenarios. The present application can be applied in any scenario where there is a demand for both communication and sensing. For example, one probable scenario is that where there are two UEs, one of the two UEs is interested in communication service and the other one is interested in sensing service while the same TRP is serving both of the two. Another is one UE interested in receiving both communication and sensing services from a TRP.

The main idea is to puncture (i.e. cutting a piece of) the sensing signal by the communication signal so that it does not interfere with communication signal in the frequency domain. While the ideal may be used for general types of sensing signal, we assume that one of the chirp-based signals is used as sensing signal to reduce power consumption and hardware complexity. Furthermore, we consider an arbitrary communication signal, e.g. orthogonal frequency division multiplexing (OFDM) signal.

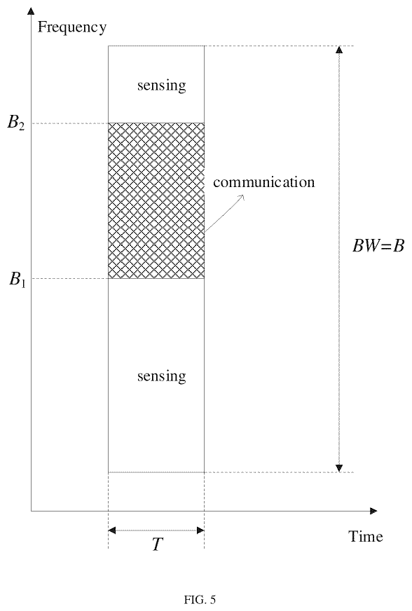

FIG. 4 is a schematic flow chart of a method (200) for processing a signal according to some embodiments of the present application. The method 200 may be implemented by a signal transmitter and a signal receiver, or a processing apparatus implemented in the signal transmitter and the signal receiver.

At step 210, a signal transmitter generates an ISAC signal.

The ISAC signal includes a sensing signal and a communication signal. A first time-frequency resource allocated to the sensing signal overlaps with a second time-frequency resource allocated to the communication signal. In the present application, the sensing signal may be a sensing chirp-based signal that will be elaborated in the following embodiments. The sensing signal is punctured by the communication signal on the overlapped time-frequency resource. In other words, the overlapped time-frequency resource is used for communication. At least one communication frequency band of a total bandwidth of the ISAC signal is allocated to the communication signal, and the rest of the total bandwidth of the ISAC signal is allocated to the sensing signal.

The general steps for generating the ISAC signal by the signal transmitter may be as follows: 1) the signal transmitter generates and punctures the sensing signal; 2) the signal transmitter generates the communication signal; and 3) the signal transmitter adds the punctured sensing signal and the communication signal to form the ISAC signal. The addition operation can occur in an analog RF domain.

At step 220, the signal transmitter transmits the ISAC signal and a puncturing indication to a first signal receiver.

Optionally, the puncturing indication may be sent before or after the ISAC signal is sent. The puncturing indication also can be sent before generation of the ISAC signal. All these options, also some options that are well-known by a person skilled in the prior art, are possible, which are not limited. In other words, orders for transmitting the ISAC signal and the puncturing indication do not matter.

The puncturing indication includes first information for processing the ISAC signal to obtain the sensing signal from the ISAC signal. In some embodiments of the present application, the first signal receiver refers to a signal receiver that is to receive the sensing signal. Therefore, the first receiver may be a sensing signal receiver which merely is to extract the sensing signal from the ISAC signal, or the first receiver may be an ISAC signal receiver which is to receive both the sensing signal and the communication signal.

Further, the signal transmitter transmits second information to a second signal receiver. The second information includes information to receive the communication signal. In other words, the second information includes the configuration of the communication signal. The second signal receiver may be an ISAC signal receiver that is to receive both the communication signal and the sensing signal, or the second signal receiver may be a communication signal receiver that is to receive the communication signal. Note that, the signal receiver receives the puncturing indication and the second information of the communication signal if the signal receiver is the ISAC signal. Otherwise, the signal receiver receives corresponding information used for receiving corresponding signal. For example, the sensing signal receiver receives the puncturing indication to extract the sensing signal within the ISAC signal, and the communication signal receiver receives the second information to extract the communication signal within the ISAC signal.

Correspondingly, a signal receiver receives the ISAC signal and the puncturing indication.

At step 230, the signal receiver filters, according to the puncturing indication, the ISAC signal to remove interference of the communication signal on the sensing signal.

At step 240, the signal receiver processes the filtered signal to obtain estimate of sensing parameter(s) of interest.

As sated above, if the signal receiver is the sensing signal receiver, the signal receiver may implement steps 230 and 240. Specifically, the general steps taken by the first signal receiver may be as follows: 1) receive puncturing indication included in control information with control signaling; 2) receive the ISAC signal; 3) filter the received signal to attenuate or remove the interference of the communication signal on the sensing signal, where there are two general approaches that can be used in this step which are elaborated in a following embodiment; and 4) process the filtered signal to obtain the estimate of sensing parameters of interest which can be range, velocity vector, angle, orientation, position, etc. Note that for the first signal receiver, a part of the required control information can be embedded in the sensing signal itself, which will be elaborated in the following embodiments.

Optionally, if the signal receiver is the ISAC signal, the signal receiver further implements a step 250 and a step 260, to obtain the communication signal from the ISAC signal.

At step 250, the signal receiver filters, according to second information, the ISAC signal to remove interference of the sensing signal on the communication signal.

At step 260, the signal receiver processes the filtered signal to decode the communication signal.

Note that, if the signal receiver is the communication signal receiver, the signal receiver merely implements the steps 250 to 260.

Specifically, the general steps taken by the communication signal receiver may be as follows: 1) receive the second information including a carrier frequency band with control signaling; 2) receive the ISAC signal; 3) filter the desired communication frequency band(s) to remove impact of the sensing signal on the sensing signal; and 4) process the filtered signal to decode the communication signal.

If the signal receiver is the ISAC signal receiver, the signal receiver implements all of the steps 230 to 260.

Besides, cases for a communication signal receiver, a sensing signal receiver and an ISAC signal receiver to receive the corresponding signal(s) are elaborated above, and there is no any limitation about how many types, for example, one type, two types or all the three types, of signal receivers exist in a communication system where the method 200 is applicable.

Details of the ISAC signal are illustrated as follows.

FIG. 5 shows one example for frequency allocation between a sensing signal and a communication signal. Note that the sensing signal is punctured by the communication signal. Typically, the bandwidth allocated to the sensing signal is much larger than the bandwidth allocated to the communication signal since the sensing signal requires a large bandwidth to enable high resolutions. Consequently, the fraction (B₂−B₁)/B in FIG. 5 is typically small in practice.

As illustrated in FIG. 5, the frequency band [B₁, B₂] is allocated to the communication signal while the rest is allocated to the sensing signal. While a single contiguous frequency band is assigned to the communication signal, the scheme can be generalized to a case where multiple contiguous frequency bands from different parts of the available bandwidth are assigned to communication, as will be explained in the following embodiments.

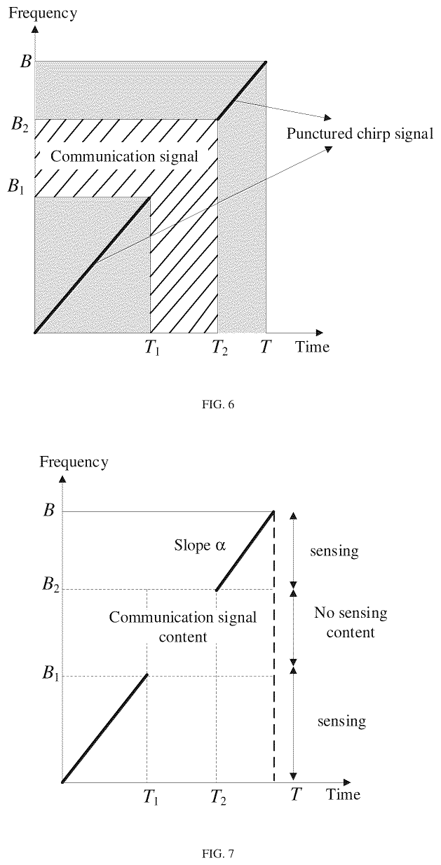

FIG. 6 is time-frequency illustration of puncturing the sensing signal by the communication signal. The communication frequency band of B₂−B₁ corresponds to a time interval of [T₁, T₂] in a time domain.

The reasons for considering contiguous frequency bands for the communication are: (1) low complexity implementation; and (2) convenient frequency domain filtering for the communication signal at the communication receiver. Note that, as a feature for chirp-based signals, puncturing a signal in time and frequency domains is equivalent, i.e. to remove the frequency content of a chirp-based signal, it is sufficient to turn off the signal in specific time intervals. This is due to the property that the chirp signal is adopted as the sensing signal and is punctured not to interfere with the communication signal, and the communication frequency band is from B₁ to B₂. To remove the content of sensing signal in this example, it is sufficient to turn off the sensing chiro signal in the time interval [T₁, T₂].

The present application is related to the ISAC signal design which affects the behavior of a transmitter and a receiver which include UEs, TRPs and may be some other nodes in a future communication system. Additionally, several new signaling exchanges are required in the present application.

Following embodiments provide more details on a type of a sensing signal that can be used. While the proposed solution may be used for general types of the sensing signal. To reduce power consumption and hardware complexity, we assume that one of the chirp-based signals is used as sensing signal. In the family of chirp-based signals, there are some special subcategories which may be used in practice. Below, more details are provided on the possibilities in terms of the sensing signal type within the chirp-based sensing signals. For simplicity, it is assumed that there is one communication frequency band [B₁, B₂] in the descriptions below. However, as will be explained later, the number of communication frequency bands can be more than one.

In the present application, chirp-based signals may include the following ones.

### (1) a Single Chirp Signal.

A single chirp signal with a positive (i.e., up chirp) chirp rate α=B/T is used for sensing as illustrated in FIG. 7, where B is the total bandwidth of the ISAC signal and T is a total time duration of the ISAC signal. The communication frequency band is [B₁, B₂]. It is sufficient to turn off the single chirp sensing signal between

$${T}_{1} = \frac{{B}_{1}}{B} T and {T}_{2} = \frac{{B}_{2}}{B} T$$

so as to remove the sensing signal frequency content that can interfere with the communication signal. Note that instead of cutting off (i.e., switching off) the sensing signal in the time interval [T₁, T₂], we can cut the sensing signal in the interval [T₁−δ₁, T₂+δ₂], where δ₂ and δ₂ create some guard band for the communication signal, T₁, T₂, δ₁ and δ₂ are positive numbers. The guard band can be used in any one of types of chirp-based signal which is used for sensing in the present application, which will not be repeated one by one.

Optionally, a single chirp signal with a negative (i.e. down chirp) chirp rate −α=−B/T is used for sensing as illustrated in FIG. 8, The sensing signal is cut off in a time interval of

$$[ {T}_{1} , {T}_{2} ] , {T}_{1} = \frac{B - {B}_{2}}{B} T ,$$

$${T}_{2} = \frac{B - {B}_{1}}{B} T .$$

### (2) FMCW Signal.

In this case, the sensing signal includes M chirp signals with a same positive chirp rate

$$α = \frac{MB}{T}$$

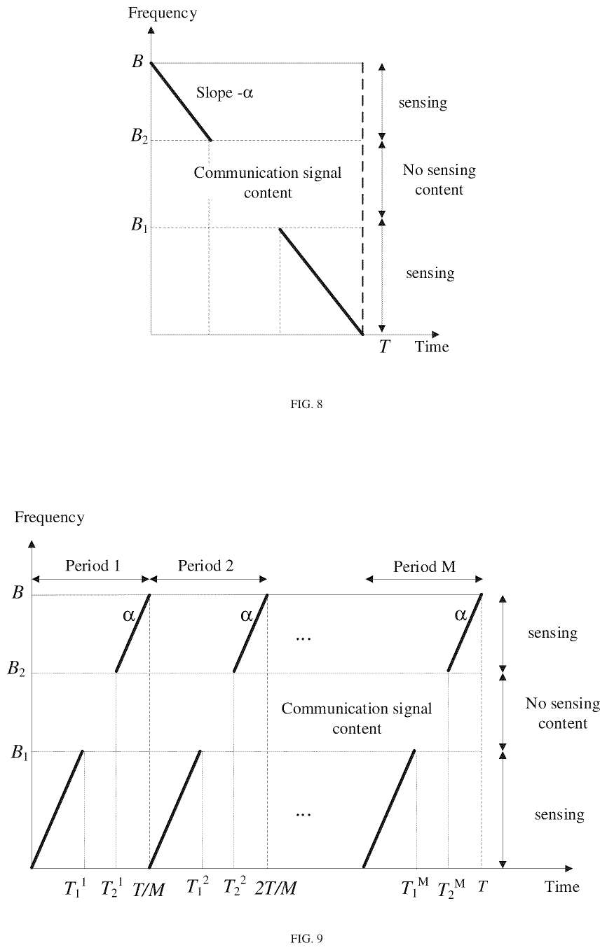

(i.e. punctured parallel up chirps) and each with a time duration T/M. FIG. 9 shows this case. Note that, the sensing signal is punctured so that the sensing signal does not have any content in the communication band [B₁, B₂], and each of the M chirp signals has to be punctured as shown in FIG. 9. To elaborate, a single chirp signal i should be cut off in a time interval

$$[ {T}_{1}^{i} , {T}_{2}^{i} ]$$

$$or$$

$$[ {T}_{1}^{i} - {δ}_{1}^{i} , {T}_{2}^{i} + {δ}_{2}^{i} ]$$

in a period i,

$${T}_{1}^{i} = \frac{T}{M} ( i - 1 + \frac{{B}_{1}}{B} )$$

$$and$$

$${T}_{2}^{i} = \frac{T}{M} ( i - 1 + \frac{{B}_{2}}{B} ) , i ∈ \{ 1 , 2 , … , M \} , {δ}_{1}^{i} and {δ}_{2}^{i}$$

are positive numbers. Since the chirp signals have the same chirp rate,

$${T}_{2}^{i} - {T}_{1}^{i} = \frac{{B}_{2} - {B}_{1}}{MB} T$$

is the same for every i.

Similar with the single chirp signal, the sensing signal may be the FMCW signal with a same negative chirp rate

$$- α = - \frac{MB}{T}$$

(i.e. punctured parallel down chirps) as illustrated in FIG. 10. In M periods, one punctured chip at each period with chirp rate

$$- α = - \frac{MB}{T}$$

and no content in the communication frequency band. The sensing signal is switched off in time interval

$$[ {T}_{1}^{i} , {T}_{2}^{i} ]$$

$$or$$

$$[ {T}_{1}^{i} - {δ}_{1}^{i} , {T}_{2}^{i} + {δ}_{2}^{i} ]$$

in a period i,

$${T}_{1}^{i} = \frac{T}{M} ( i - \frac{{B}_{2}}{B} ) ,$$

$${T}_{2}^{i} = \frac{T}{M} ( i - \frac{{B}_{1}}{B} ) , i ∈ \{ 1 , 2 , … , M \} , {δ}_{1}^{i} and {δ}_{2}^{i}$$

are positive numbers.

### (3) Triangular Signal

In this case, the sensing signal may be a single up-ward triangular signal including a positive chirp rate

$$α = \frac{2 B}{T}$$

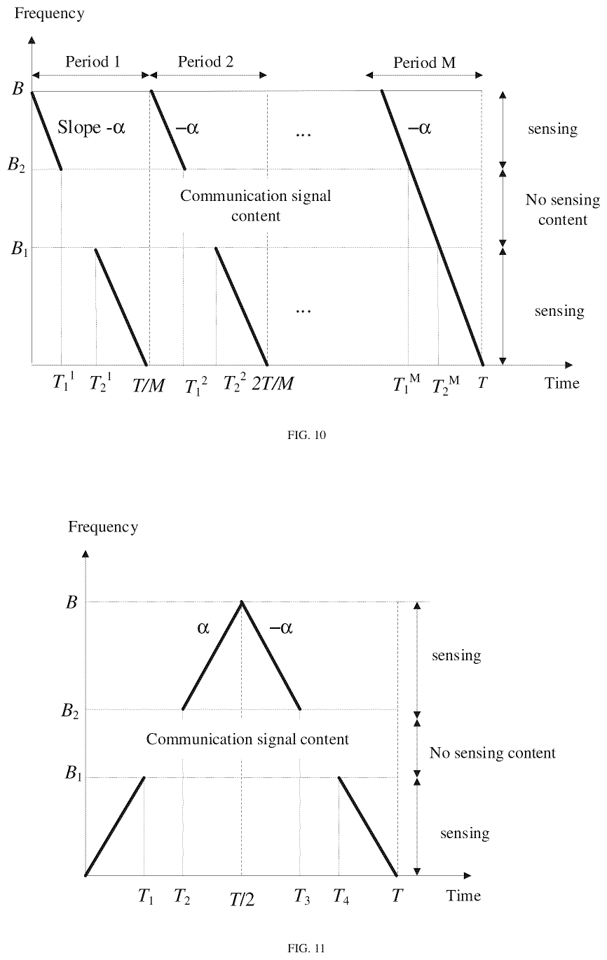

in a first period and then a negative chirp rate-a in a second period as illustrated in FIG. 11. Each of the two periods includes a punctured chirp with no content in the communication frequency band. Each of the two chirp signals has a time duration-. For puncturing, a first chirp signal should be cut off from

$${T}_{1} = \frac{{B}_{1}}{2 B} T$$

$$to$$

$${T}_{2} = \frac{{B}_{2}}{2 B} T ,$$

and a second chirp signal should be cut off from

$${T}_{3} = T - \frac{{B}_{2}}{2 B} T$$

$$to$$

$${T}_{4} = T - \frac{{B}_{1}}{2 B} T .$$

Besides, in the case, a guard band can be used in the time interval [T₁, T₂] or the time interval [T₃, T₄]. For example, the single up-ward triangular signal may be cut off in a time interval [T₁−δ₁, T₂+δ₂] and a time interval [T₃-δ₃, T₄+δ₄], δ₁, δ₂, δ₃, and δ₄ are positive numbers.

In another case, the sensing signal may be a single down-ward triangular signal including a negative chirp rate

$$- α = - \frac{2 B}{T}$$

in a first period and then a positive chirp rate

$$α = \frac{2 B}{T}$$

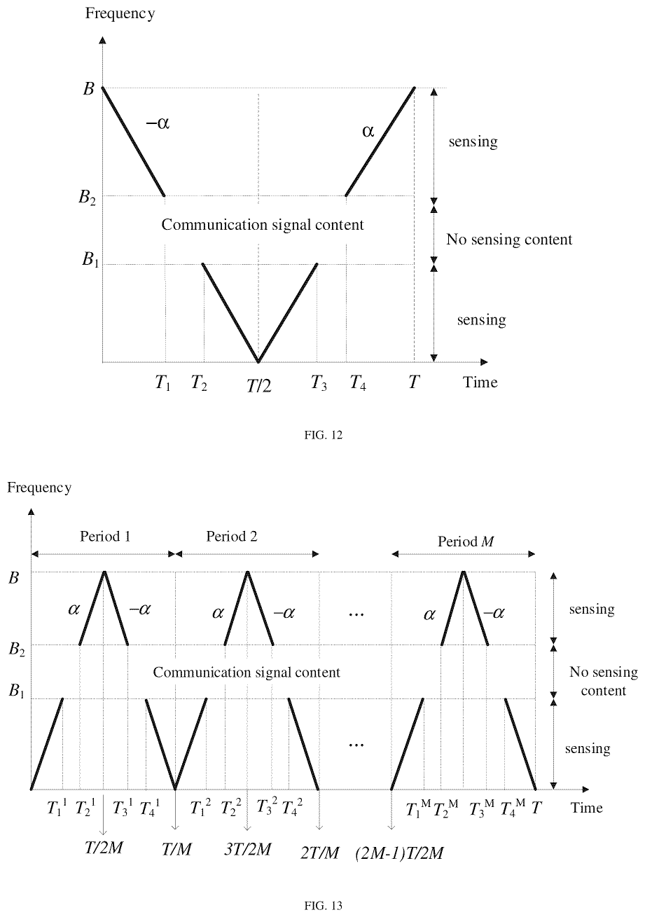

in a second period as illustrated in FIG. 12. Each of the two periods includes a punctured chirp with no content in the communication frequency band, and each of the two chirp signals has a time duration T/2. A first chirp signal should be cut off from

$${T}_{1} = \frac{B - {B}_{2}}{2 B} T$$

$$to$$

$${T}_{2} = \frac{B - {B}_{1}}{2 B} T ,$$

and a second chirp signal should be cut off from

$${T}_{3} = \frac{T}{2} ( 1 + \frac{{B}_{1}}{B} ) to {T}_{4} = \frac{T}{2} ( 1 + \frac{{B}_{2}}{B} ) .$$

Similarly, a guard band can be used in the time interval [T₁, T₂], for example, [T₁−δ₁, T₂+δ₂], and/or the time interval [T₃, T₄], for example, [T₃−δ₃, T₄+δ₄] where δ₁, δ₂, δ₃, and δ₄ are positive numbers.

Besides, the sensing signal may be a triangular signal that includes M chirp signals instead of one. For example, two general cases of the triangular signal are provided, i.e. a case with M upward triangular signal and another one with M downward triangular signals.
a) FIG. 13 shows the case with M upward triangular signals.

There are M periods, two punctured conjugate chirps at each period with chirp rates

$$α = 2 \frac{M B}{T}$$

and −α for the first and second chirp respectively, and no content in the communication band. The sensing signal is cut off in a time interval of [T₁, T₂] and a time interval of [T₃, T₄] in period i,

$${T}_{1}^{i} = \frac{( i - 1 ) T}{M} + \frac{T}{2 M} \frac{{B}_{1}}{B} , {T}_{2}^{i} = \frac{( i - 1 ) T}{M} + \frac{T}{2 M} \frac{{B}_{2}}{B} ,$$

$${T}_{3}^{i} = \frac{( i - 1 ) T}{M} + \frac{T}{M} ( 1 - \frac{{B}_{2}}{2 B} ) , {T}_{4}^{i} = \frac{( i - 1 ) T}{M} + \frac{T}{M} ( 1 - \frac{{B}_{1}}{2 B} ) ,$$

$$i ∈ \{ 1 , 2 , … , M \} ,$$

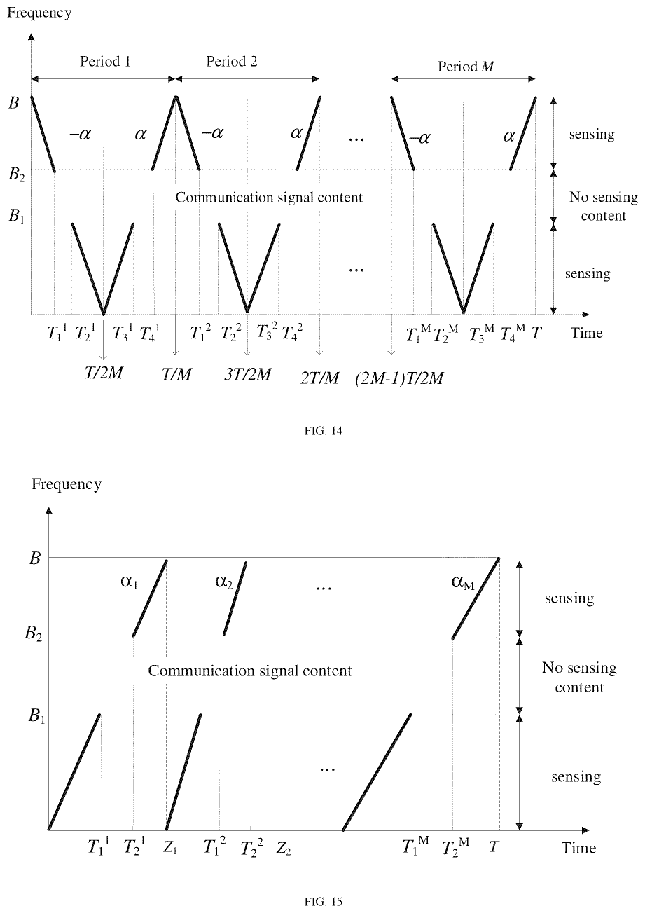

M is a positive integer equals to or greater than two.
b) FIG. 14 shows the case with M downward triangular signals.

There are also M periods, two punctured conjugate chirps at each period with chirp rates

$$- α = - 2 \frac{M B}{T}$$

and α for a first and second chirp respectively, and no content in the communication band. The sensing signal is switched off in time durations of [T₁, T₂] and [T₃, T₄]

$${T}_{1}^{i} = \frac{( i - 1 ) T}{M} + \frac{T}{2 M} \frac{B - {B}_{2}}{B} , {T}_{2}^{i} = \frac{( i - 1 ) T}{M} + \frac{T}{2 M} \frac{B - {B}_{1}}{B} ,$$

$${T}_{3}^{i} = \frac{( i - 1 ) T}{M} + \frac{T}{2 M} ( 1 + \frac{{B}_{1}}{B} ) , {T}_{4}^{i} = \frac{( i - 1 ) T}{M} + \frac{T}{2 M} ( 1 + \frac{{B}_{2}}{B} ) ,$$

$$i ∈ \{ 1 , 2 , … , M \} ,$$

M is a positive integer equals to or greater than two.

### (4) General Chirp-Based Signal.

In this case, a general chirp-based signal is used for sensing including M single chirp signals with same or different chirp rates per chirp signal.

FIG. 15 shows an example of this sensing signal. To puncture the sensing signal so that it does not have any content in the communication band [B₁, B₂]. Each individual chirp signal in the FMCW signal has to be punctured as shown in FIG. 15. To elaborate, the chirp signal i should be cut off between

$${T}_{1}^{i} and {T}_{2}^{i} , i ∈ \{ 1 , 2 , … , M \} .$$

### The

$${T}_{1}^{i} and {T}_{2}^{i}$$

can be obtained as a function of B, T, B₁, B₂, and a sequence of the chirp rates corresponding to different chirp signals. Since the chirp signals may have different chirp rates, the chirp rate

$${T}_{2}^{i} - {T}_{1}^{i}$$

is not necessary the same for every i. Note that, all the chirp rates in FIG. 15 are positive, which is just an example. In other cases, the chirp rate can be negative per chirp signal. Besides, the chirp rate of the M chirp signals can be positive or negative per chirp signal. All these cases are applicable in the present application. Additionally, all the chirp rates in FIG. 15 have the same starting frequency, which is just an example. In other cases, the starting frequency can vary across chirp signals. In fact, any one of the parameters including the chirp rate, the starting frequency, and the chirp duration can vary across different chirps in the general LFM based signals. Other LFM based signals such as the FMCW signal and the triangular signal are special cases of this type. All these cases are applicable in the present application.

According to all the four cases introduced above, it can be shown that summation of the duration of all the cut off intervals of the sensing signal is equal to

$$\frac{{B}_{2} - {B}_{1}}{B} T$$

irrespective of the type of the chirp-based sensing signal and the number of the chirp signals included in the chirp-based sensing signal. Therefore, puncturing reduces the sensing signal energy proportional to the fraction

$$1 - \frac{{B}_{2} - {B}_{1}}{B} .$$

In practice, typically this fraction is close to 1 since sensing requires a relatively large bandwidth.

FIG. 16 illustrates more details of the ISAC transmitter when the sensing signal is taken to be a generalized chirp-based signal described in above embodiments.

Following embodiments provide more details on the possible approaches for removing or filtering the mutual interference between the sensing signal and the communication signal in the setting of the present application. There are two types of interferences in ISAC scenarios.

### (1) a First Type of Interference: Interference of the Sensing Signal on the Communication Signal.

The first type of interference can be removed or attenuated using frequency filtering at the communication receiver. The design of the ISAC signal in the present application is in such a way that allows for convenient frequency domain filtering at the communication receiver. This is more or less what the communication receiver should do even without the sensing signal in order to remove the impact of out-of-band signals. Using such filtering can minimize the impact of sensing signal on the communication performance.

### (2) a Second Type of Interference: Interference of the Communication on the Sensing Signal.

Let T and T_{com} denote time durations of the ISAC and the communication signal, respectively. To attenuate the impact of communication interference on sensing performance, two general scenarios are considered, and the present application provides an approach for each of the two general scenarios.
Scenario 1) fraction

$$\frac{{T}_{c o m}}{T}$$

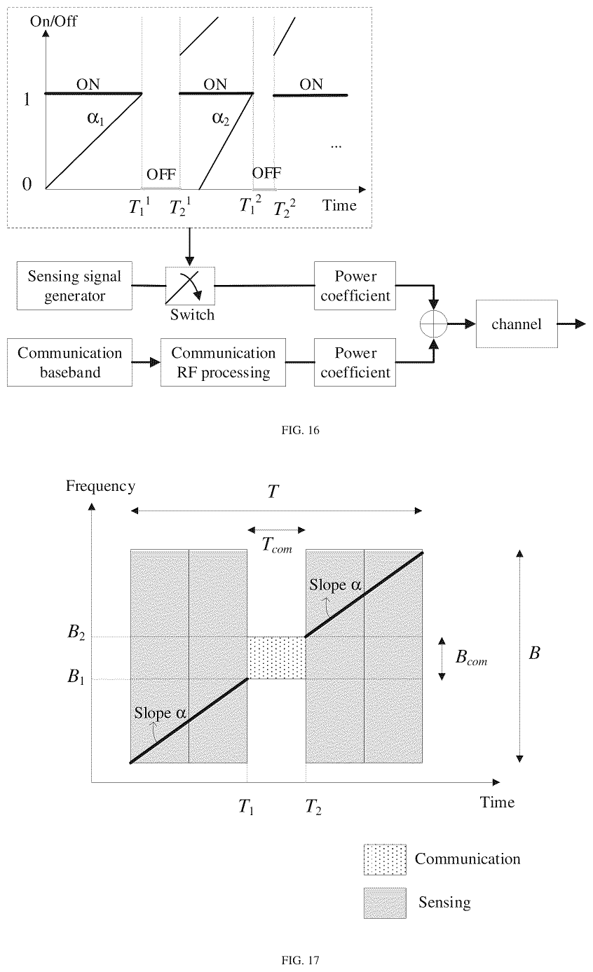

is a small (see an example shown in FIG. 17).

In this scenario, time-domain filtering (in this context, what the time filtering means is to remove samples after sampling in the time domain) can be used at the first signal receiver to remove the impact of communication on sensing. The first signal receiver samples the ISAC signal and removes the “polluted” time samples belonging to [T₁, T₂] which is the time interval of the communication signal and T_{com}=T₂−T₁. Such samples are called polluted since the communication signal is sent in that interval making interference for the sensing signal. In this case, the first signal receiver should be aware of T₁ and T₂ to be able to identify and remove the polluted samples. The T₁ and T₂ can be sent to the first signal receiver through signaling, as will be explained with more details later. Note that this scenario requires the least behavior change for the first signal receiver and hence is more suitable for low-power mode sensing receivers.
Scenario 2) fraction

$$\frac{{T}_{c o m}}{T}$$

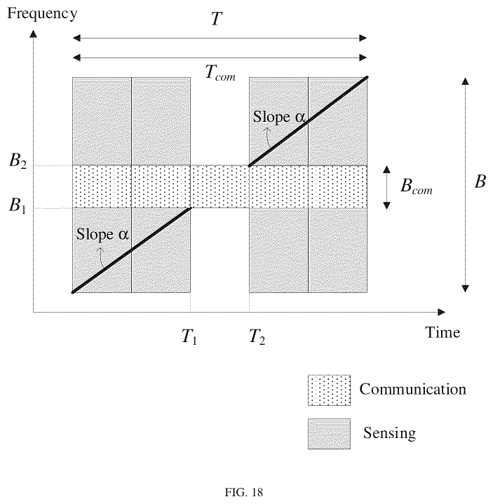

is large (see an example shown in FIG. 18).

In this scenario, frequency-domain filtering (before sampling) can be used at the first signal receiver to remove the impact of communication on sensing. To this end, the first signal receiver can apply a notch filter to remove the frequency content of the communication signal before sampling. This would lead to sensing signal samples which are not polluted with communication signal interference. To perform this notch filtering, the first signal receiver should have a capability of notch frequency filtering and it should know the communication frequency band boundaries B₁ and B₂. The capability of notch filtering can be signaled from the first signal receiver to the network before the transmission of IASC signal. The B₁ and B₂ can also be signaled to the first signal receiver by the network. Note that in this scenario we cannot use the time-filtering as most of the sensing signal samples are polluted due to having a large

$$\frac{{T}_{com}}{T} .$$

As stated above, the transmitted ISAC signal is received by the communication signal receiver and the sensing signal receiver. Note that, the communication signal receiver and the sensing signal receiver may be located at different nodes or the same node, which is not limited.

Depending on the type of approach taken for handling the communication interference on sensing signal (both in the first and second scenarios), different structures may be used for the first signal receiver (for example, the sensing signal receiver, or a part, used for receiving the sensing signal, of the ISAC signal receiver).

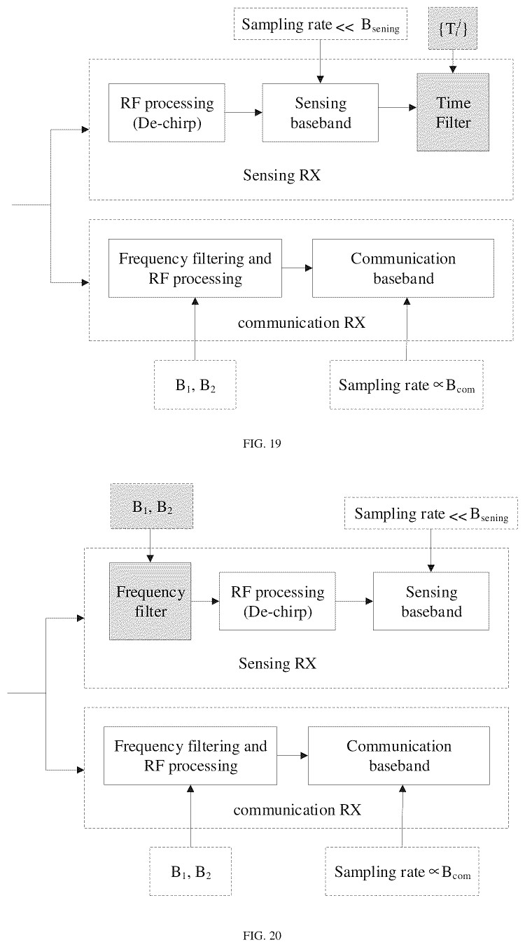

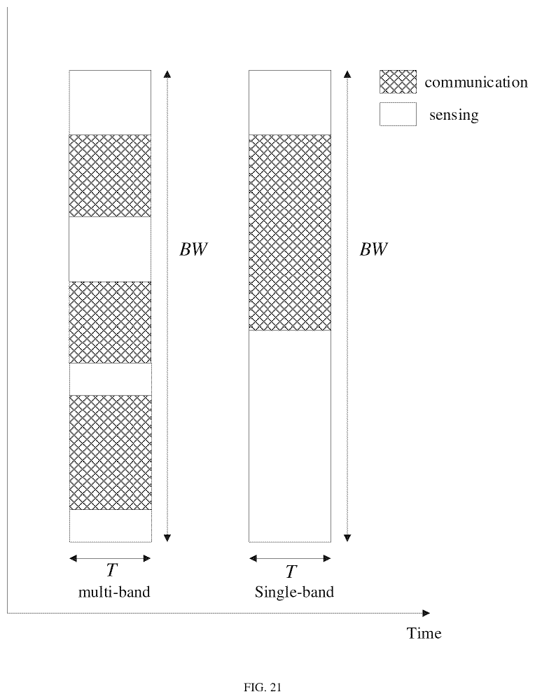

FIG. 19 illustrates more details of one possible option for ISAC receiver when 1) the sensing signal is taken to be a chirp-based signal and 2) the approach provided in the first scenario is adopted. In this figure,

$$\{ {T}_{i}^{j} \}$$

is the set of time instants corresponding to the puncturing of the chirp signal which depend on the type of the chirp signal as explained in above embodiments. In this figure, B_{sensing} refers to a frequency bandwidth for the sensing signal, and B_{com} refers to a total frequency bandwidth for the communication signal.

FIG. 20 is a counterpart of FIG. 19 with the same assumptions except we assume the second scenario described above is adopted. That is to say, this figure is one possible option for the ISAC signal receiver when 1) the sensing signal is taken to be a chirp-based signal and 2) the approach provided in the second scenario is adopted. Note that in both figures, the communication signal receiver is the same and only the sensing signal receiver is different.

In the procedure of the method 200, signaling exchanges are involved. In the following embodiment, we focus on the first signal receiver as there are obvious behavior changes. Note that, a first signal receiver can be a consumer device such as a user equipment (UE) or even a network device. The first signal receiver requires the following control information.

### (1) Sensing Signal Configuration

In the case using the chirp-based signal, the sensing signal configuration includes one or more of: a type of the chirp-based signal, the number of the chirp signals comprised in the chirp-based signal, chirp rate(s) of chirp signal(s) comprised in the chirp-based signal, starting frequency of the chirp-based signal, a bandwidth of the chirp-based signal, and the type of the chirp-based signal is used to indicate the chirp-based signal is the single chirp signal, the FMCW signal, the triangular signal or a general chirp-based signal. These parameters can be sent to the first signal receiver using control signaling such as radio resource control (RRC) or medium access control-control element (MAC-CE).

### (2) Puncturing Indication.

The puncturing indication includes one or more of the following parameters.
(a) the scenario that is used, i.e. the first or the second scenario. The first signal receiver requires this information to properly process the received ISAC signal.
(b) if the first scenario is chosen, the puncturing indication includes values of T₁ and T₂. If the first scenario is chosen, the first signal receiver should know the values of the T₁ and T₂, which are indications of the beginning and ending of communication signal in time domain. This information is required to identify and remove the polluted samples.
(c) if the second scenario is chosen, the puncturing indication includes values of B₁ and B₂. If the second scenario is chosen, the first signal receiver should know the values of the B₁ and B₂, which are indications of beginning and ending of the communication signal in frequency domain. This information is required to apply notch filtering to remove interference of the communication signal on the sensing signal. Note that here we assumed there is one communication frequency band. However, it is possible to have more communication bands within the total bandwidth of the ISAC signal. In such cases, the beginning and ending of each communication frequency band should be signaled to the first signal receiver.

Another issue is how to signal the puncturing indication to the first signal receiver, and the following options are further provided:
Option 1: broadcasting the puncturing indication in a broadcast message over the same beam direction over which the communication signal is transmitted. In this case, all the first signal receivers would receive the puncturing indication and can behave appropriately. For example, in this option, the puncturing indication can be sent at the same time as sending the control information over physical downlink control channel (PDCCH) for the communication receivers. This option is especially required when frequency filtering (the second scenario) is to be used at the first signal receiver since the first signal receiver requires to know the puncturing indication in advance so as to be able to tune its filter.
Option 2: the puncturing indication is transmitted on top of the chirp-based sensing signal. In other words, the puncturing indication is embedded as data on the chirp-based signal. This option may be useful when the time-domain filtering (the first scenario) is used and when the communication resources are pre-configured. To elaborate, it is possible that the communication band is pre-configured within a large sensing band. However, sometimes the communication signal is not present as there is no demand for communication service in such cases the signal transmitter can send the chirp-based sensing signal alone while embedding one bit (or a couple of bits if required) in the chirp-based sensing signal to let the signal receiver know that there is no communication signal hence there is no need for filtering to handle the interference. Additionally, in some scenarios, the network may get a demand for communication. For example, there may be a sudden demand for an urgent communication. In such scenarios, the signal transmitter can use puncturing to create the ISAC signal and also embed one or more bits in the chirp-based sensing signal to let the first signal receiver know that the communication signal is present. Subsequently, the first signal receiver can apply proper filtering based on the received puncturing indication to remove or alleviate the interference caused by the communication signal. This is especially useful if the communication resources can be shared with the sensing receivers in advance and the transmitter only needs to let the sensing receiver know if the communication signal is present or not. This can be done by embedding one bit in the chirp-based sensing signal.

Besides, the first signal receiver may transmit a capability report to the signal transmitter before transmission of the ISAC signal. The capability report is to indicate whether the first signal receiver is capable of notch filtering in a frequency domain. This can be done by using the RRC or the MAC-CE signaling.

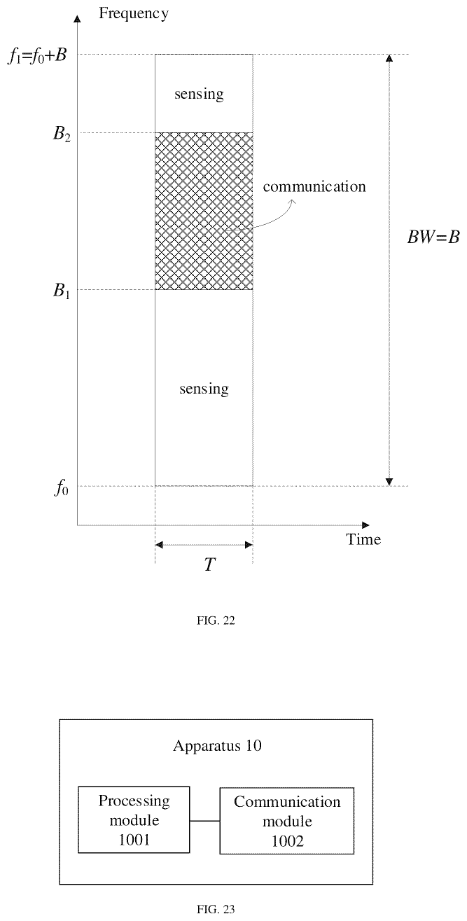

So far, we considered the case where there is a single frequency band. This embodiment provides more details on the generalized case where there are multiple communication frequency bands. FIG. 21 illustrates both single communication frequency band and multiple frequency bands. It should be noted that, in the case of multiple bands, the puncturing indication is the set of the puncturing indications for all communication bands. Furthermore, the sensing receiver should filter the communication signals of all communication bands, either in time or frequency to remove or alleviate the interference caused by transmission of the communication signal.

Besides, in all the above embodiments, it is assumed that the starting frequency of the ISAC signal is zero, i.e. the ISAC signal frequency band is [0, B], however, it is possible to generalize the formulas for non-zero values of starting frequency of the ISAC frequency band. In such cases, the frequency band of the ISAC signal is [f₀, f₁], where f₁−f₀=B or equivalently f₁=f₀+B as illustrated in FIG. 22. In such cases, all the formulas for the beginning and ending of the cut-off time intervals (for example T₁ and T₂ in FIG. 7) are still valid except that we should use B₁−f₀ instead of B₁, and B₂−f₀ instead of B₂. In other words, the values for the boundaries of the communication band(s) used in the formulas, should be shifted down by f₀.

The method proposed in embodiments of the present application is described in detail above, and a communication apparatus provided by the present application will be described in detail below.

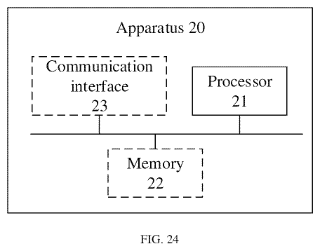

FIG. 23 is a schematic block diagram of an apparatus 10 according to some embodiments of the present application. The apparatus may be a communication device or an apparatus implemented in a communication device and capable of realizing corresponding functions of any one of the embodiments of the present application. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. The communication device may be the signal transmitter, the signal receiver, or the apparatus implemented in any one of these communication devices.

The apparatus 10 includes a processing module 1001. The processing module 1001 may be a processor, a processing circuit, a processing board, a processing unit, or a processing device, et al. The processing module 1001 is configured to implement processing and/or operations implemented inside the communication apparatus except sending the receiving actions.

The apparatus 10 may further include a communication module 1002. The communication unit 1002 is configured to implement a sending action and/or a receiving action. The communication module 1002 also may be called as a transceiver module, a transceiver, or a transceiver device, et al, and is configured to implement operations of receiving (which may be referred to as inputting) and/or sending (which may be referred to as outputting).

For example, if the apparatus 10 corresponds to the ISAC signal transmitter in FIG. 4, the communication module 1002 is configured to implement step 220. The processing module 1001 is configured to implement step 210. If the apparatus 10 corresponds to the sensing signal receiver in FIG. 4, the communication module 1002 is configured to receive the ISAC signal and the puncturing indication from the ISAC signal transmitter.

For example, if the apparatus 10 corresponds to the communication signal receiver in FIG. 4, the communication module 1002 is configured to receive the ISAC signal from the ISAC signal transmitter. The communication module 1002 is further configured to receive second information from the ISAC signal transmitter which is not shown in FIG. 4. The processing module 1001 is configured to implement a step 250 and a step 260.

Briefly, the operations and/or functions of the apparatus 10 are intended to implement corresponding steps of the foregoing method embodiments.

FIG. 24 is a schematic block diagram of an apparatus according to some embodiments of the present application. The apparatus 20 includes at least one processor 21. The at least one processor 21 is coupled to at least one memory 22. The at least one memory 22 is configured to store one or more instructions and/or executable computer code. The at least one processor 21 is configured to invoke the one or more instructions and/or executable computer code, so that the apparatus 20 implements the method provided in the embodiments of the present application. Optionally, the apparatus 20 may further include the at least one memory 22. Optionally, the apparatus 20 may further include at least one communication interface 23, and the at least one communication interface 23 is configured to input and/or output information or data.

In an implementation, the apparatus 20 may be any one of the communication devices in the method embodiments. For example, the apparatus 20 may be the ISAC signal transmitter, the signal receiver (for example, the sensing signal receiver, the communication signal receiver or the ISAC signal receiver). In this implementation, the processor 21 may be a baseband apparatus, and the communication interface 23 may be a radio frequency apparatus.

In another implementation, the apparatus 20 may be implemented in a communication device such as the ISAC signal transmitter and the signal receiver. In this case, the apparatus may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. In this implementation, the processor 21 may be a logical module or circuit that is part of the integrated circuit. The communication interface 23 may be a transceiver, an interface circuit, an input/output interface, a bus, a module, a pin, or other types of interfaces.

An embodiment of the present application further provides a communication system. The communication system may include the ISAC transmitter and any one of the types of the signal receivers introduced in the above embodiments. For example, the communication system may include the ISAC transmitter and the sensing signal receiver, the ISAC transmitter and the communication signal receiver, or the ISAC transmitter and both of the sensing signal receiver and the communication signal receiver, which is not limited.

An embodiment of the present application further provides a computer storage medium, and the computer storage medium may store one or more instructions for executing any of the foregoing methods.

An embodiment of the present application further provides a computer program product, and the computer program product may store one or more instructions for executing any of the foregoing methods.

In the embodiments of this application, “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: Only A exists, both A and B exist, and only B exists.

Besides, the use of a singular form of “a”, “an” and “the” in the embodiments of the present application and the claims appended hereto is also intended to include a plural form, unless otherwise clearly indicated herein by context.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a ROM, a RAM, a magnetic disk, an optical disc or the like.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments. In addition, functional units in the embodiments of this application may be integrated into one processing unit, or each of the units may exist alone physically, or two or more units are integrated into one unit.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An apparatus comprising:
at least one processor; and
a memory coupled to the at least one processor, the memory for storing instructions that, when executed by the at least one processor, cause the apparatus to perform operations including:
generating an integrated sensing and communication (ISAC) signal, wherein the ISAC signal comprises a sensing signal and a communication signal, a first time-frequency resource allocated to the sensing signal overlaps with a second time-frequency resource allocated to the communication signal, the sensing signal comprises a linear frequency modulation based (LFM-based) signal, the sensing signal is punctured by the communication signal on an overlapped time-frequency resource between the first time-frequency resource and the second time-frequency resource, at least one communication frequency band of a total bandwidth of the ISAC signal is allocated to the communication signal, and the rest of the total bandwidth of the ISAC signal is allocated to the sensing signal;
transmitting the ISAC signal; and
transmitting a puncturing indication to a first signal receiver, wherein the puncturing indication comprises first information for processing the ISAC signal to obtain the sensing signal from the ISAC signal.

2. The apparatus of claim 1, wherein the total bandwidth B of the ISAC signal corresponds to frequency boundaries f₀ and f₁, wherein B=f₁−f₀, and the at least one communication frequency band comprises a first communication frequency band of [B₁, B₂], wherein B₁≥f₀, and wherein B₂≤f₁.

3. The apparatus of claim 1, wherein the sensing signal is a single LFM signal, and the sensing signal is cut off in a first time interval that is a part of a total time duration of the ISAC signal.

4. The apparatus of claim 1, wherein the sensing signal is a frequency modulated continuous waveform (FMCW) signal comprising M LFM signals with a same chirp rate and a same time duration, and each of the M LFM signals is cut off in a first time interval, and wherein M is a positive integer greater than one.

5. The apparatus of claim 1, wherein the sensing signal is a single triangular signal comprising a first LFM signal and a second LFM signal, the first LFM signal is cut off in a first time interval, and the second LFM signal is cut off in a second time interval.

6. The apparatus of claim 1, wherein the sensing signal is a triangular signal comprising 2M LFM signals, the 2M LFM signals comprises M first LFM signal(s) and M second LFM signal(s), a first chirp rate of the M first LFM signal(s) and a second chirp rate of the M second LFM signal(s) are the opposite, each of the 2M LFM signal(s) is allocated with a time duration of
$$\frac{T}{2 M} ,$$
each of the M first LFM signal(s) is cut off in a first time interval, and each of the M second LFM signal(s) is cut off in a second time interval, M is a positive integer greater than one, and T is a total time duration of the ISAC signal.

7. The apparatus of claim 1, wherein the LFM-based signal comprises M single LFM signals with a same chirp rate or with different chirp rates per LFM signal, and each of the M single LFM signals is cut off in a time interval.

8. The apparatus of claim 1, wherein the generating the ISAC signal comprises:
generating and puncturing the sensing signal;
generating the communication signal; and
combining the punctured sensing signal and the communication signal to form the ISAC signal.

9. The apparatus of claim 1, wherein the operations further comprise:
receiving a capability report from the first signal receiver, wherein the capability report indicates whether the first signal receiver is capable of notch filtering in a frequency domain.

10. The apparatus of claim 1, wherein the first information indicates sensing signal configuration, the sensing signal configuration comprises one or more parameters of: a type of the LFM-based signal indicating the LFM-based signal is a single LFM signal, a number of LFM signals comprised in the LFM-based signal, chirp rate(s) of LFM signal(s) comprised in the LFM-based signal, a beginning frequency of the LFM-based signal, and a bandwidth of the LFM-based signal, an FMCW signal, a triangular signal, or a general LFM-based signal.

11. An apparatus comprising:
at least one processor; and
a memory coupled to the at least one processor, the memory for storing instructions that, when executed by the at least one processor, cause the apparatus to perform operations including:
receiving an integrated sensing and communication (ISAC) signal and a puncturing indication, wherein the ISAC signal comprises a sensing signal and a communication signal, a first time-frequency resource allocated to the sensing signal overlaps with a second time-frequency resource allocated to the communication signal, the sensing signal comprises a linear frequency modulation based (LFM-based) signal, the sensing signal is punctured by the communication signal on an overlapped time-frequency resource between the first time-frequency resource and the second time-frequency resource, at least one communication frequency band of a total bandwidth of the ISAC signal is allocated to the communication signal, the rest of the total bandwidth of the ISAC signal is allocated to the sensing signal, and the puncturing indication comprises first information for processing the ISAC signal to obtain the sensing signal from the ISAC signal;
filtering, according to the puncturing indication, the ISAC signal to remove interference of the communication signal on the sensing signal; and
processing the filtered ISAC signal to obtain estimate of sensing parameter(s) of interest.

12. The apparatus of claim 11, wherein the total bandwidth B of the ISAC signal corresponds to frequency boundaries f₀ and f₁, wherein B=f₁−f₀, wherein the at least one communication frequency band comprises a first communication frequency band of [B₁, B₂], wherein B₁≥f₀, and wherein B₂≤f₁.

13. The apparatus of claim 11, wherein the operations further comprise:
transmitting a capability report, wherein the capability report indicates whether the apparatus is capable of notch filtering in a frequency domain.

14. The apparatus of claim 11, wherein the first information indicates sensing signal configuration, the sensing signal configuration comprises one or more parameters of: a type of the LFM-based signal indicating the LFM-based signal is a single LFM signal, a number of LFM signals comprised in the LFM-based signal, chirp rate(s) of LFM signal(s) comprised in the LFM-based signal, a beginning frequency of the LFM-based signal, and a bandwidth of the LFM-based signal, a frequency modulated continuous waveform (FMCW) signal, a triangular signal or a general LFM-based signal.

15. The apparatus of claim 11, wherein the puncturing indication further indicates all beginnings and endings of the communication signal in the time domain.

16. The apparatus of claim 11, wherein the puncturing indication further indicates frequency boundaries of each of the at least one communication frequency band.

17. The apparatus of claim 11, wherein the operations further comprise:
filtering, according to second information, the ISAC signal to remove interference of the sensing signal on the communication signal; and
processing the filtered ISAC signal to decode the communication signal.

18. An apparatus comprising:
at least one processor; and
a memory coupled to the at least one processor, the memory for storing instructions that, when executed by the at least one processor, cause the apparatus to perform operations including:
receiving an integrated sensing and communication (ISAC) signal, wherein the ISAC signal comprises a sensing signal and a communication signal, a first time-frequency resource allocated to the sensing signal overlaps with a second time-frequency resource allocated to the communication signal, the sensing signal comprises a linear frequency modulation based (LFM-based) signal, the sensing signal is punctured by the communication signal on an overlapped time-frequency resource between the first time-frequency resource and the second time-frequency resource, at least one communication frequency band of a total bandwidth of the ISAC signal is allocated to the communication signal, and the rest of the total bandwidth of the ISAC signal is allocated to the sensing signal;
filtering the at least one communication frequency band to remove interference of the sensing signal on the communication signal; and
processing the communication signal to decode the communication signal.

19. The apparatus of claim 18, wherein the total bandwidth B of the ISAC signal corresponds to frequency boundaries f₀ and f₁, wherein B=f₁−f₀, wherein the at least one communication frequency band comprises a first communication frequency band of [B₁, B₂], whereinB1≥f₀, and wherein B₂≤f₁.

20. The apparatus of claim 18, wherein the operations further comprise:
receiving second information that indicates the at least one communication frequency band; and
the filtering the at least one communication frequency band comprises:
filtering the at least one communication frequency band according to the second information, to remove the interference of the sensing signal on the communication signal.
